(19) United States
(12) Patent Application Publication
(10) Pub. No.: US 2017/0140434 A1
(43) Pub. Date: May 18, 2017

(54) ADVERTISEMENT AND MESSAGE PUSHING SYSTEM

(71) Applicant: Yu-shun Lin, TAIPEI CITY (TW)

(72) Inventor: Yu-shun Lin, TAIPEI CITY (TW)

(21) Appl. No.: 15/355,594

(22) Filed: Nov. 18, 2016

(30) Foreign Application Priority Data
Nov. 18, 2015 (TW) 104137997

(51) Int. Cl. G06Q 30/02; H04W 4/00; H04W 4/20; H04L 29/08

(52) U.S. Cl. CPC G06Q 30/0267; H04L 67/26; H04W 4/008; H04W 4/206; H04W 88/08

(57) ABSTRACT

A system for pushing advertisement and message on a mobile device includes a pushing server and at least one Bluetooth base station, wherein a plurality sets of pushing signals are stored in the pushing server, and the Bluetooth base station includes a first Bluetooth module and a network module. The Bluetooth base station and the pushing server build a network connection via the network module, and Bluetooth base station and the mobile device build a Bluetooth connection via the first Bluetooth module when the mobile device is in the Bluetooth broadcasting area of the Bluetooth base station. The pushing server transmits at least one set of the pushing signals, and then the first Bluetooth module of the Bluetooth base station executes a Bluetooth signal broadcasting to transmit the contents of the received pushing signals to the mobile device.

### BACKGROUND OF THE INVENTION

1. Field of the Invention

The present invention relates to an advertisement and message pushing system, and more particularly, to a system automatically detecting when a mobile device approaches within a region that can receive a Bluetooth signal broadcasting, and then transmitting a Bluetooth packet to the mobile device, so that the wireless mobile device displays the corresponding advertisement and message according to the packet.

2. Description of the Prior Art

Push technology is a kind of technology to transfer information to the terminal, and based on the current vigorous development of smart mobile devices and wireless networks, push technology can help users of the mobile devices to receive messages or advertisements that they are interested in. For merchants, such technology that automatically sends advertisements or messages to customers who are interested in can find potential customers and promote trade more easily.

In the prior art, the mechanism that wireless network is used to detect when the mobile device approaches and then push the broadcast message, including Apple iBeacon, Google Beacon, etc. The prior art of broadcasting messages can broadcast fixed content via Bluetooth device, but cannot push dynamic content. Therefore, when the above-mentioned prior art is used in the actual advertisement application requirements, a plurality of broadcasting devices are need to be set simultaneously and the mobile device needs to be under the status of wireless network connection to implement advertisement applications. Setting a plurality of broadcasting devices simultaneously will lead to higher cost, and the mobile device required to be under the status of wireless network connection will be restricted for the application situation.

In order to solve the above-mentioned questions, it is necessary to design a kind of new advertisement and message pushing system, so that users of the mobile devices can receive a variety of advertisement content that is suitable for the time and space.

### SUMMARY OF THE INVENTION

An object of the present invention is to provide a new advertisement and message pushing system that can push different advertisements or messages on a mobile device in different time and places.

To achieve the above objectives, the advertisement and message pushing system of the present invention can comprise a pushing server and at least one Bluetooth base station. The pushing server stores a plurality sets of pushing signals, and each set of pushing signal comprises different pushing content respectively. The Bluetooth base station comprises a first Bluetooth module and a network module respectively, and builds a network connection with the pushing server via the network module; when the mobile device approaches to the Bluetooth base station within a region that can receive a Bluetooth signal broadcasting, the Bluetooth base station can build a Bluetooth connection with the mobile device via the first Bluetooth module. The pushing server can transmit at least one set of the pushing signals to the Bluetooth base station via the network connection, and then the Bluetooth base station can transmit the pushing content of the pushing signals to the mobile device via the Bluetooth connection.

According to another embodiment of the present invention, the above-mentioned system further comprises a program set on the mobile device. When the mobile device approaches to the Bluetooth base station within the region that can receive the Bluetooth signal broadcasting, the program receives the pushing signals received by the mobile device from the Bluetooth base station, and display the pushing content of the pushing signals through words, images or sounds on a display interface of the mobile device.

Therefore, the advertisement and message pushing system of the present invention can push different advertisements or messages on the mobile device of the users in different times and places to achieve diversity and dynamic advertisement content.

The advantages and spirits of the invention may be understood by the following recitations together with the appended drawings.

### BRIEF DESCRIPTION OF THE APPENDED DRAWINGS

Some of the embodiments will be described in detail, with reference to the following figures, wherein like designations denote like members, wherein:

FIG. 1 shows a schematic diagram of the advertisement and message pushing system in an embodiment of the present invention.

FIG. 2 shows a schematic diagram of the advertisement and message pushing system in another embodiment of the present invention.

FIG. 3 shows a schematic diagram of the method of making sure the time precision of the Bluetooth broadcasting device in FIG. 2 in another embodiment of the present invention.

FIG. 4 shows a schematic diagram of the advertisement and message pushing system in another embodiment of the present invention.

FIG. 5 shows a schematic diagram of the advertisement and message pushing system in another embodiment of the present invention.

FIG. 6 shows a schematic diagram of the advertisement and message pushing system in another embodiment of the present invention.

### DETAILED DESCRIPTION OF THE INVENTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims.

The scope of the present invention will in no way be limited to the number of constituting components, the materials thereof, the shapes thereof, the relative arrangement thereof, etc., and are disclosed simply as an example of embodiments of the present invention.

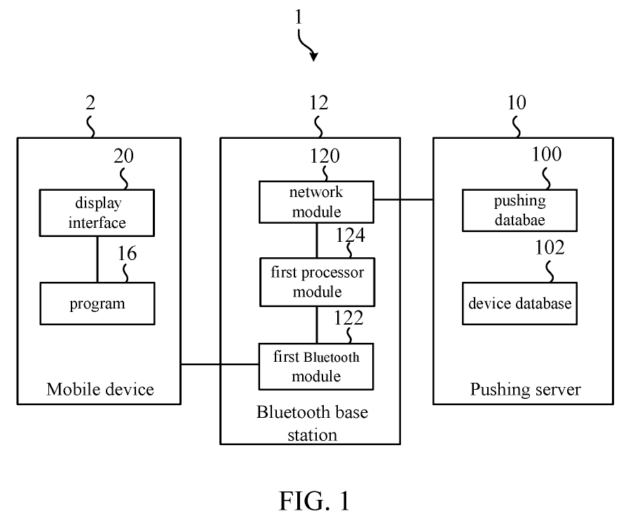

Please refer to FIG. 1. FIG. 1 shows a schematic diagram of the advertisement and message pushing system 1 in an embodiment of the present invention. As shown in FIG. 1, the advertisement and message pushing system 1 comprises a pushing server 10 and a Bluetooth base station 12, wherein the Bluetooth base station 12 can further comprise a network module 120, a first Bluetooth module 122 and a first processor module 124, and the network module 120 and the first Bluetooth module 122 are connected to the first processor module 124 respectively to be controlled by the first processor module 124. The Bluetooth base station 12 can build the network connection with the pushing server 10 via the network module 120. In the practice application, the network connection between the Bluetooth base station 12 and the pushing server 10 can be wired or wireless. The pushing server 10 comprises the pushing database 100, wherein a plurality set of pushing signals are stored in the pushing server 10, and the pushing signals comprise a pushing content and a time setting respectively. Therefore, the pushing server 10 can transmit a set of the pushing signals or a plurality set of pushing signals in the pushing database 100 to the Bluetooth base station 12 via the network connection.

The first Bluetooth module 122 of the Bluetooth base station 12 has a region that the Bluetooth broadcasting signal exists, when the mobile device 2 enters the region that the Bluetooth broadcasting signal exists, the mobile device 2 can receive the Bluetooth broadcasting signal sent from the Bluetooth base station 12. In the practice application, the mobile device 2 can be a smart phone or a PAD, and the mobile device 2 can be equipped with the third Bluetooth module, the display interface, the wireless mobile communication module, the wireless local area network module and the processor. When the mobile device 2 enters the Bluetooth broadcasting signal region of the Bluetooth base station 12, the mobile device 2 can build a Bluetooth connection with the Bluetooth base station 12 via the first Bluetooth module 122 and the third Bluetooth module of the mobile device 2. Therefore, the Bluetooth base station 12 and the mobile device 2 can transmit the Bluetooth signal to each other via the Bluetooth connection. Please note that FIG. 1 only shows one Bluetooth base station 12 and one mobile device 2, but the present invention is not limited to it, for example, one Bluetooth base station 12 can build the Bluetooth connection with a plurality of mobile devices 2 within the Bluetooth broadcasting signal region, and the advertisement and message pushing system 1 can also comprise a plurality of Bluetooth base stations 12 to build the Bluetooth connection with one mobile device 2 or a plurality of mobile devices 2.

In the practice application, the Bluetooth module of the mobile device 2 and the first Bluetooth module 122 of the Bluetooth base station 12 can be any version of the Bluetooth protocol specification defined by the Bluetooth association, such as the Bluetooth device defined by Bluetooth 2.0 protocol series, Bluetooth 3.0 protocol or Bluetooth 4.0 protocol series. The network module of the Bluetooth base station can be Ethernet, VDSL, ADSL, WiFi wireless local area network or wireless mobile communication module.

The first processor module 124 of the Bluetooth base station 12 can further comprise an embedded timing unit; besides, in the practice application, the processor module 124 further comprises a processor and non-volatile memory, which is omitted for the purpose of concise drawing. The time setting of the timing unit can use Network Time Protocol (NTP) or IEEE1588 to get the precision time to make sure the accuracy of time of the timing unit of the processor module 33.

In the embodiment of the present invention, except for the pushing database 100, the pushing server 10 can further comprise the device database 102 for storing the connective corresponding relation between the mobile device 2 and the Bluetooth base station 12. In the practice application, the pushing server can further comprise a user database, a user interface and API.

As mentioned above, the pushing database 100 of the pushing server 10 stores a set of pushing signals or a plurality sets of pushing signals, wherein the content of the pushing signals can comprise pushing header, pushing data and pushing option. Furthermore, the pushing header can comprise pushing identification code and pushing object code, and the pushing identification code can provide the recognition of the unique code for each pushing signal, and the pushing object code can correspond to one or a plurality of the Bluetooth base stations, one or a plurality of the mobile devices or other device that can build the Bluetooth connection with the Bluetooth base station.

The pushing data of the pushing signals can comprise the pushing content and the extended data, wherein the pushing content can be a coding, a paragraph, an Uniform Resource Identifier, sound file format, image file format, video file format or other digitized content, and the extended data can be a coding, a paragraph, an Uniform Resource Identifier, sound file format, image file format, video file format or other digitized content.

The pushing option of the pushing signals comprises pushing format, service identifier, pushing frequency, pushing time, pushing times, pushing mask, pushing group, etc. Wherein, the pushing format is the presentation format of the pushing broadcasting, such as Apple iBeacon, Google EddyStone; if the pushing format is 0, it represents broadcasting in all formats. The service identifier is the specific coding defined by the pushing format for recognizing the Bluetooth device that transmits the pushing signals. The pushing frequency can set the range of 0.1 Hz to 60 Hz. The pushing time setting can be represented by different methods such as starting time and pushing time, starting time and ending time, daily fixed time, weekly fixed time, monthly fixed time or a fixed time in a specific time interval, and the starting time of the pushing time can be a specific number, such as 0, maximum or minimum value, to represent the specific attributes of the pushing, such as instant pushing or unlimited pushing. The pushing mask of the pushing signals can be a binary encoded value, wherein each bit or several bits represent one attribute. That is to say that the pushing mask is the target customer mask according to the classification based on the user attributes, wherein the user attributes can comprise: gender, age, ethnicity, preference, interest, sport, community, country, place of residence, one or a plurality of service identifiers, and different pushing masks are corresponding to different target customers. Therefore, the above-mentioned set of the pushing mask represents the target customers aimed by the pushing signals; the pushing group of the pushing signals is an integer value, wherein each number represents a kind of the collection of the user attribute data, and the user attributes can comprise: gender, age, ethnicity, preference, interest, sport, community, country, place of residence, one or a plurality of service identifiers.

The above-mentioned comparison method of the pushing mask and the user attributes is AND of the bit. In other words, if the result of the binary AND operation processed by a user attribute data is the same as a pushing mask, then the comparison is passed. Besides, the above-mentioned comparison method of the pushing group and the user attributes is confirming the value equal. In other words, if a pushing group value is the same as a user attribute data, then the comparison is passed.

The pushing database of the pushing server can store the data of a user or a plurality of users, and the user data stores at least one or a plurality of the user attributes of a user, and the above-mentioned user attributes comprise: gender, age, ethnicity, preference, interest, sport, community, country, place of residence, etc. In another embodiment, the user data can further store the reaction attributes to the pushing content of the user, and the above-mentioned reaction attributes comprise open, unread, unread deleted, read deleted, dwell time, click through content, unread state time, read retention time, etc.

The device database of the pushing server stores the connective corresponding relation between the mobile device and the Bluetooth base station, furthermore, stores extended Bluetooth device and the connective corresponding relation with the Bluetooth base station, wherein the Bluetooth device also comprises the Bluetooth module. Besides, the user of the pushing server and the program interface (API) can edit or modify the database content of the pushing server.

The Bluetooth base station 12 builds the network connection with the pushing server 10 via the network module 120, and the network connection can be built through the network of Internet service provider or the internal network of enterprise via wired LAN, wireless LAN, wireless mobile communication network or other wired or wireless network mechanism. The network connection is a TCP/IP or upper layer protocol connection, such as HTTP, HTTPS, TLS, SSL, MQTT, TELNET or any protocol based on TCP or UDP.

When the Bluetooth base station 12 builds the Bluetooth connection with a Bluetooth device 12 or when a Bluetooth base station 12 receives a connectable packet sent from a Bluetooth device via the first Bluetooth module 122, the Bluetooth base station 12 can notice the pushing server 10 to update the connective corresponding relation between the Bluetooth device and the Bluetooth base station 12 in the device database 102 via the network connection.

When the Bluetooth base station 12 builds the Bluetooth connection with any one of the Bluetooth device 12 or when a mobile device 2 receives a connectable packet sent from any one of the Bluetooth device 12 via the first Bluetooth module 122, the mobile device 2 can notice the pushing server 10 to update the connective corresponding relation between the mobile device 2 and the Bluetooth base station 12 or the connective corresponding relation between the Bluetooth device and the Bluetooth base station 12 in the device database 102 via the network connection.

As mentioned above, the pushing header of the pushing signals can comprise pushing object code, and the pushing object code can correspond to one or a plurality of Bluetooth base stations, one or a plurality of mobile devices or other Bluetooth device that can build the Bluetooth connection with the Bluetooth base station. When the pushing header of the pushing signals correspond to one or a plurality of the Bluetooth base station 12, the pushing server 10 sends the pushing signals to the corresponding Bluetooth base station 12 via the network connection with the Bluetooth base station 12.

On the other hand, when the pushing header of the pushing signals correspond to one or a plurality of the mobile device 2, the pushing server 10 searches for the device database 102 of the pushing server 10 to get the Bluetooth base station 12 corresponding to mobile device 2, and then the pushing server 10 sends the pushing signals to the corresponding Bluetooth base station 12 via the network connection with the Bluetooth base station 12.

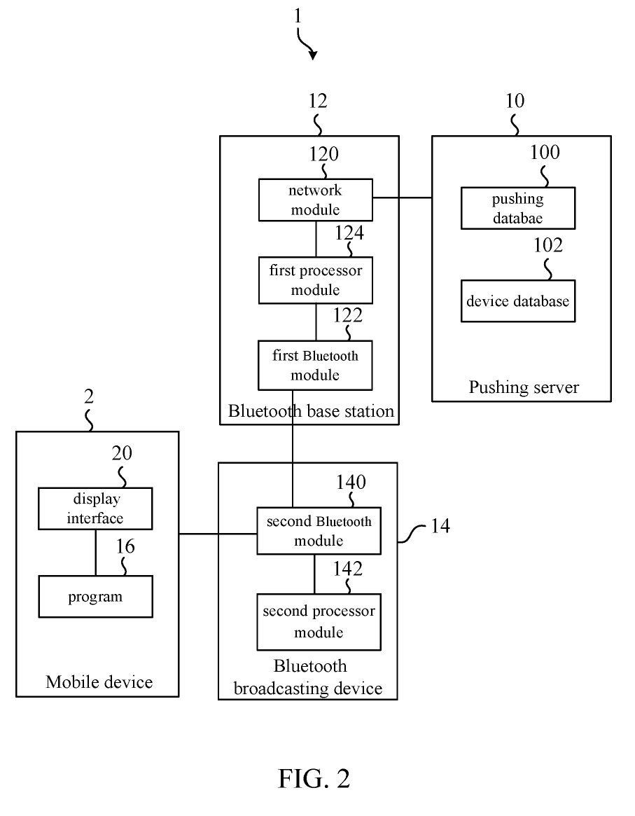

Please refer to FIG. 2. FIG. 2 shows a schematic diagram of the advertisement and message pushing system 1 in another embodiment of the present invention. As shown in FIG. 2, the embodiment of the present invention is different from the above embodiment that the advertisement and message pushing system 1 of the embodiment of the present invention further comprises a Bluetooth broadcasting device 14 except for the units mentioned above. The Bluetooth broadcasting device further comprises a seond Bluetooth module 140, a second processor module 142, wherein and the seond Bluetooth module 140 is connected to the second processor module 142 to be controlled by the second processor module 142. In the practice application, the second Bluetooth module 140 can be any version of the Bluetooth protocol specification defined by the Bluetooth association, such as the Bluetooth device defined by Bluetooth 2.0 protocol series, Bluetooth 3.0 protocol or Bluetooth 4.0 protocol series. The processor module 142 is the same as the above-mentioned first processor module and comprises processor, timing unit and non-volatile memory.

In the embodiment of the present invention, the Bluetooth base station 12 builds the first Bluetooth connection with the seond Bluetooth module 140 of the Bluetooth broadcasting device 14 via the first Bluetooth module 122, and the Bluetooth connection can be initially built via the Bluetooth broadcasting device 14 or the Bluetooth base station 12, but the present invention does not limit to the above mentioned. After the Bluetooth base station 12 builds the first Bluetooth connection, the Bluetooth base station 12 notices the pushing server 10 to update the connective corresponding relation between the Bluetooth broadcasting device 14 and the Bluetooth base station 12 in the device database 102 via the Bluetooth base station 12 and the network connection of the pushing server 10. That is to say, the Bluetooth broadcasting device 14 is the same as the above-mentioned Bluetooth device. Please notice that the other units of the advertisement and message pushing system 1 of the embodiment of the present invention are the same as the corresponding units of the above embodiment, therefore details will not repeated herein again.

In the practice application, to make sure the accuracy of time of the timing unit of the second processor module 142, the first Bluetooth connection is used to update time. The method to update time can be transmitting the time value in the timing unit of the first processor module 124 of the Bluetooth base station 12 to the Bluetooth broadcasting device 14 via the first Bluetooth connection to cover the time value in the timing unit of the second processor module 142

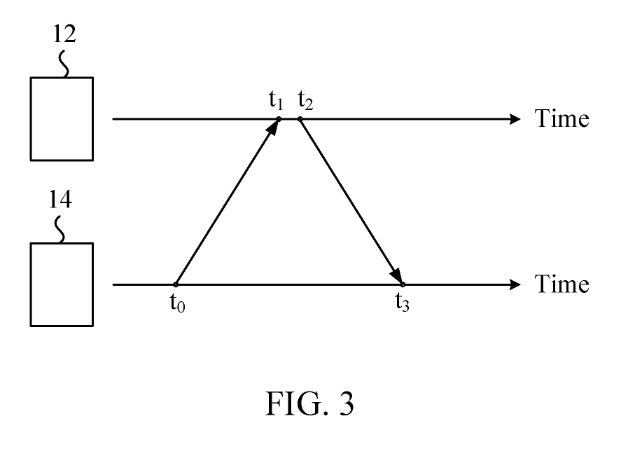

Except for the above-mentioned method of covering the time value directly via the Bluetooth base station 12 to make sure the accuracy of time of the Bluetooth broadcasting device 14, the method of offset variable delay via the first Bluetooth connection can also be used to implement. Please refer to FIG. 3. FIG. 3 shows a schematic diagram of the method of making sure the time precision of the Bluetooth broadcasting device 14 in FIG. 2 in another embodiment of the present invention. As shown in FIG. 3, to make sure the accuracy of time of the timing unit of the Bluetooth broadcasting device 14, the time of the timing unit can be implemented via the method of offset variable delay, and the following is the detailed description of this method,

θ is the average time drift value calculated from the once time correction procedure, and the calculation method is as following:

$$θ = \frac{( {t}_{1} - {t}_{0} ) + ( {t}_{2} - {t}_{3} )}{2} ,$$

wherein t0 is a time stamp of the time correction packet transmitted from the Bluetooth broadcasting device 14; t1 is the time stamp of the time correction packet received by the Bluetooth base station 12; t2 is a time stamp of the reply packet transmitted from the Bluetooth base station 12, and the reply packet replies to the request of the time correction packet; t3 is the time stamp of the reply packet received by the Bluetooth broadcasting device 14.

After calculating a plurality of times of the time correction procedure, a plurality of the average time drift values can be calculated, and a predicted value of the drift time can be calculated through processing average calculation to the plurality of the average time drift values. In the embodiment of the present invention, the predicted value of the drift time can be used to correct the drift time of the Bluetooth base station 12 and the Bluetooth broadcasting device 14, to descript in details, in the calculation the time of the timing unit of the Bluetooth base station 12 plus the predicted value of the drift time as the time of the timing unit of the Bluetooth broadcasting device 14.

Besides, the signal transmission of the Bluetooth connection will be delayed. If a delay of back and forth of the signal is set as δ, the equation is as following:

δ=(t₃−t₀)−(t₂−t₁),

for example, if t0 is 231 ms, and t1 is 135 ms, and t2 is 137 ms, and t3 is 298 ms in FIG. 3, δ is 65 ms as calculated by the above-mentioned equation.

Please refer to FIG. 2 again. After the pushing signals are inputted and stored in the pushing database 100, if the pushing object of the pushing signals is one or a plurality of the Bluetooth broadcasting device 14, the pushing server 10 in FIG. 2 searches in the device database 102 and gets one or a plurality of the Bluetooth base station 12 correspondingly connected to the Bluetooth broadcasting device 14 of the pushing object, and then the pushing server 10 sends the pushing signals to the corresponding Bluetooth base station 12 via the network connection with the Bluetooth base station 12.

After the Bluetooth base station 12 in each of the above embodiments receives a pushing signal via the network connection with the pushing server 10, the

Bluetooth base station 12 can process Bluetooth broadcasting set according to the pushing option and the pushing content of the pushing signals. The Bluetooth broadcasting set can comprise a setting item, and the setting item can comprise pushing format, service identifier, pushing frequency, pushing time, pushing times, pushing mask or pushing group, pushing content and pushing object. The pushing format, service identifier, pushing frequency, pushing time, pushing times and pushing mask or pushing group of the Bluetooth broadcasting set mentioned above can be the pushing format, service identifier, pushing frequency, pushing time, pushing times and pushing mask or pushing group of the pushing option of the pushing signals, and the pushing content is the pushing content of the pushing data of the pushing signals. Only when the pushing object of the pushing signals is one or a plurality of mobile devices, the pushing object of the Bluetooth broadcasting set is the identifier of the above-mentioned mobile device; otherwise, it is a null value or 0.

The Bluetooth base station 12 can build one or a plurality of Bluetooth connection with one or a plurality of the Bluetooth broadcasting device 14, and the Bluetooth base station 12 can package at least one set of the pushing signals as one or a plurality of pushing signals, wherein the pushing signals of each Bluetooth can comprise the pushing option, the pushing content and the pushing object. The pushing content of the Bluetooth pushing signals is the pushing content of the pushing signals; the Bluetooth pushing option of the pushing signals is the pushing option of the pushing signals. Only when the pushing object of the pushing signals is one or a plurality of the mobile device 2, the pushing object of the Bluetooth pushing signals is the identifier of each mobile device 2; otherwise, it is a null value or 0. Therefore, the Bluetooth base station 12 can transmit the above-mentioned Bluetooth pushing signals to each Bluetooth broadcasting device 14 via the Bluetooth connection.

After the Bluetooth broadcasting device 14 receives the Bluetooth pushing signals, the Bluetooth broadcasting device 14 can process Bluetooth broadcasting set according to the pushing content and the pushing option of the pushing signals. The Bluetooth broadcasting set can comprise one or a plurality of setting items and a pushing object, wherein the setting items can comprise pushing format, service identifier, pushing frequency, pushing time, pushing times, pushing mask or pushing group and pushing content. The pushing format, service identifier, pushing frequency, pushing time, pushing times and pushing mask or pushing group of the Bluetooth broadcasting set mentioned above can be the pushing format, service identifier, pushing frequency, pushing time, pushing times and pushing mask or pushing group of the pushing option of the Bluetooth pushing signals, and the pushing content of the Bluetooth broadcasting set can be the pushing content of the Bluetooth pushing signals, and the pushing object of the Bluetooth broadcasting set is the pushing object of the Bluetooth pushing signals.

Therefore, each Bluetooth broadcasting device 14 can transmit the Bluetooth broadcasting according to the pushing format, pushing frequency, pushing time and pushing times of the setting items of the Bluetooth broadcasting set, wherein the Bluetooth broadcasting transmits a Bluetooth format broadcasting packet according to the pushing format, and the Bluetooth format broadcasting packet can comprise the service identifier of the setting items of the Bluetooth broadcasting set, such as Apple iBeacon, Google EddyStone or other Bluetooth broadcasting packet defined by other standards. In the practice application, if the pushing format is 0, the Bluetooth broadcasting packet defined by each format is transmitted one by one according to various formats. Next, the Bluetooth broadcasting device 14 transmits one or a plurality of Bluetooth signal broadcasting packets, and the Bluetooth signal broadcasting packets can comprise the pushing content, the pushing object and the pushing content, the pushing mask and the pushing content or the pushing group and the pushing content of the setting items of the Bluetooth broadcasting set.

As shown in FIG. 1 and FIG. 2, the advertisement and message pushing system 1 can further comprise a program 16 set on the mobile device 2. According to the operating system specification of the mobile device, the program 16 can register one or a plurality of service identifiers. When the mobile device 2 approaches to the Bluetooth broadcasting device 14 or the Bluetooth base station 12 within a region that can receive the above-mentioned Bluetooth broadcasting of the Bluetooth device, the third Bluetooth module of the mobile device 2 can receive the above-mentioned Bluetooth format broadcasting packet, and if the received Bluetooth format broadcasting packet has the service identifier registered by the program 16, the program 16 is started according to the operating system mechanism of the mobile device 2. Next, the program 16 can receive one or a plurality of subsequent Bluetooth signal broadcasting packets via the third Bluetooth module, and control the mobile device 2 to display the pushing content of the Bluetooth signal broadcasting packet through words, images or sounds on the display interface 20.

According to another embodiment of the present invention, the mobile device 2 (like each above-mentioned embodiment) can build the program 16 and an identifier. Similarly, according to the operating system specification of the mobile device, the program 16 can register one or a plurality of service identifiers. When the mobile device 2 approaches to the Bluetooth broadcasting device 14 or the Bluetooth base station 12 within a region that can receive the above-mentioned Bluetooth broadcasting of the Bluetooth device, the third Bluetooth module of the mobile device 2 can receive the above-mentioned Bluetooth format broadcasting packet, and if the received Bluetooth format broadcasting packet has the service identifier registered by the program 16, the program 16 is started according to the operating system mechanism of the mobile device 2. Next, the program 16 can receive one or a plurality of subsequent Bluetooth signal broadcasting packets via the third Bluetooth module. And, if the pushing object of the Bluetooth signal broadcasting packet comprises identifier of the mobile device 2, the program 16 displays the pushing content of the Bluetooth signal broadcasting packet through words, images or sounds on the display interface 20 of the mobile device 2. Otherwise, the program 16 ignores and does not display the Bluetooth signal broadcasting packet.

According to another embodiment of the present invention, the mobile device 2 (like each above-mentioned embodiment) can build the program 16 and a user data file, wherein the user data file comprises all kinds of the user attributes, comprising gender, age, ethnicity, preference, interest, sport, community, country, place of residence. Similarly, according to the operating system specification of the mobile device, the program 16 can register one or a plurality of service identifiers. When the mobile device 2 approaches to the Bluetooth broadcasting device 14 or the Bluetooth base station 12 within a region that can receive the above-mentioned Bluetooth broadcasting of the Bluetooth device, the mobile device 2 can receive the above-mentioned Bluetooth format broadcasting packet. And, if the received Bluetooth format broadcasting packet has the service identifier registered by the program 16, the program 16 is started according to the operating system mechanism of the mobile device 2. Next, the program 16 can receive one or a plurality of subsequent Bluetooth signal broadcasting packets and compare the pushing mask of the Bluetooth signal broadcasting packet to the user data file to determine whether the user of the mobile device 2 is the target customer of the pushing mask. If the result of the comparison is satisfied, (that is to say, the user of the mobile device 2 is the target customer of the pushing mask), the program 16 of the mobile device 2 displays the pushing content of the Bluetooth signal broadcasting packet through words, images or sounds on the display interface 20; and if the user is not the target customer, the program 16 of the mobile device 2 can ignore or display the pushing content of the Bluetooth signal broadcasting packet according to the rule defined by the user.

According to another embodiment of the present invention, the mobile device 2 (like each above-mentioned embodiment) can build the program 16 and a user data file, wherein the user data file comprises all kinds of the user attributes, the pushing history records and the user reviews, and the above-mentioned attributes comprise gender, age, ethnicity, preference, interest, sport, community, country, place of residence. Similarly, according to the operating system specification of the mobile device, each of the program 16 can register one or a plurality of service identifiers. When the mobile device 2 approaches to the Bluetooth broadcasting device 14 or the Bluetooth base station 12 within a region that can receive the above-mentioned Bluetooth broadcasting of the Bluetooth device, the mobile device 2 can receive the above-mentioned Bluetooth format broadcasting packet, and if the received Bluetooth format broadcasting packet has the service identifier registered by the program 16, the program 16 is started according to the operating system mechanism of the mobile device 2. Next, the program 16 can receive one or a plurality of subsequent Bluetooth signal broadcasting packets and compare the pushing mask of the Bluetooth signal broadcasting packet to the user data file to determine whether the user is the target customer of the pushing mask. If the result of the comparison is satisfied, (that is to say, the user of the mobile device 2 is the target customer of the pushing mask), the program 16 of the mobile device 2 displays the pushing content of the Bluetooth signal broadcasting packet through words, images or sounds on the display interface 20; and if the user is not the target customer, the program 16 of the mobile device 2 can ignore or display the pushing content of the Bluetooth signal broadcasting packet according to the rule defined by the user.

According to another embodiment of the present invention, when the mobile device 2 approaches to the Bluetooth broadcasting device 14 or the Bluetooth base station 12 within a region that can receive the above-mentioned Bluetooth broadcasting of the Bluetooth device, the mobile device 2 can receive the above-mentioned Bluetooth format broadcasting packet, and if the received Bluetooth format broadcasting packet has the service identifier registered by the program 16, the program 16 is started according to the operating system mechanism of the mobile device 2. The program 16 can build the Internet connection with the above-mentioned pushing server 10 via the wireless mobile communication module or the wireless local area network module of the mobile device 2, and transmit the service identifier to the pushing server via the Internet. The pushing server 40 searches for the corresponding at least one pushing signal in the pushing database 100 of the pushing server 10 according to the received service identifier, and then transmits the extended data of the at least one pushing signal to the mobile device 2, and the mobile device 2 displays through words, images, sounds or URL form via the browser.

According to another embodiment of the present invention, after the above-mentioned Bluetooth base station 12 receives a pushing signal via the network connection between the Bluetooth base station 12 and the pushing server 10, if the pushing object is one or a plurality of the mobile devices, the Bluetooth base station 12 processes the Bluetooth broadcasting according to the pushing format, pushing frequency, pushing time of the pushing option of the pushing signal. In the embodiment of the present invention, the Bluetooth broadcasting transmits the Bluetooth format broadcasting packet according to the pushing format, and the Bluetooth format broadcasting packet can be Apple iBeacon, Google EddyStone or other Bluetooth broadcasting packet defined by other standards. Or if the pushing format is 0, the Bluetooth broadcasting packet is transmitted one by one according to various formats. Besides, the Bluetooth format broadcasting packet further comprises Bluetooth SMS service identifier. Next, the Bluetooth base station 12 transmits one or a plurality of the Bluetooth SMS service broadcasting packets, comprising the identifier of the mobile device 2. The mobile device 2 can build the program 16, and the program 16 can register the Bluetooth SMS service identifier in the operating system of the mobile device 2. The identifier of the mobile device 2 is the unique identification code of each mobile device. When the mobile device 2 approaches to the Bluetooth base station 12 within a region that can receive the Bluetooth broadcasting of the Bluetooth base station 12, the mobile device 2 can receive the Bluetooth format broadcasting packet, and if the Bluetooth SMS service broadcasting packet of the Bluetooth format broadcasting packet is in accordance with the Bluetooth SMS service broadcasting packet registered by the program 16 in the operating system of the mobile device 2, the program 16 is started according to the operating system mechanism of the mobile device 2. Next, the program 16 can receive one or a plurality of subsequent Bluetooth SMS service broadcasting packets. And, if the Bluetooth SMS service broadcasting packet comprises the identifier of the mobile device 2, the mobile device 2 can build a Bluetooth connection with the Bluetooth base station 12, so that the Bluetooth base station 12 can transmit the pushing content of the pushing signals to each mobile device 2 via the Bluetooth connection.

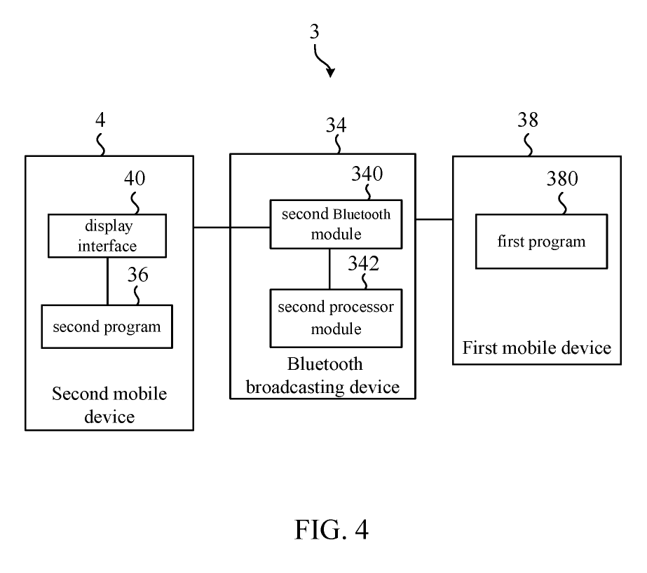

The Bluetooth pushing signals can be updated via another mobile device except the above-mentioned Bluetooth base station or Bluetooth broadcasting device according to the pushing signals. Please refer to FIG. 4. FIG. 4 shows a schematic diagram of the advertisement and message pushing system 2 in another embodiment of the present invention. As shown in FIG. 4, the embodiment of the present invention is different from the above embodiments that the advertisement and message pushing system 3 of the embodiment of the present invention further comprises a first mobile device 38, and the first mobile device 38 further comprises a first program 380, wherein the first program 380 can edit one or a plurality of the pushing signals. When the first mobile device 38 approaches to the Bluetooth broadcasting device 34 within a region that the first mobile device 38 can process the Bluetooth connection with the Bluetooth broadcasting device 34, the first mobile device 38 builds the Bluetooth connection with the Bluetooth broadcasting device 34, and the first mobile device 38 can update the Bluetooth pushing signals edited by the first program 380 to the Bluetooth broadcasting device 34 via the Bluetooth connection. Besides, the Bluetooth broadcasting device 34 can process the time calibration with the first mobile device 38 via the Bluetooth connection. The Bluetooth broadcasting device 34 can push the updated pushing signals to the second mobile device 4, and the second program 36 set on the second mobile device 4 can control the second mobile device 4 to display the Bluetooth pushing content of the pushing signals through words, images or sounds on the display interface 40.

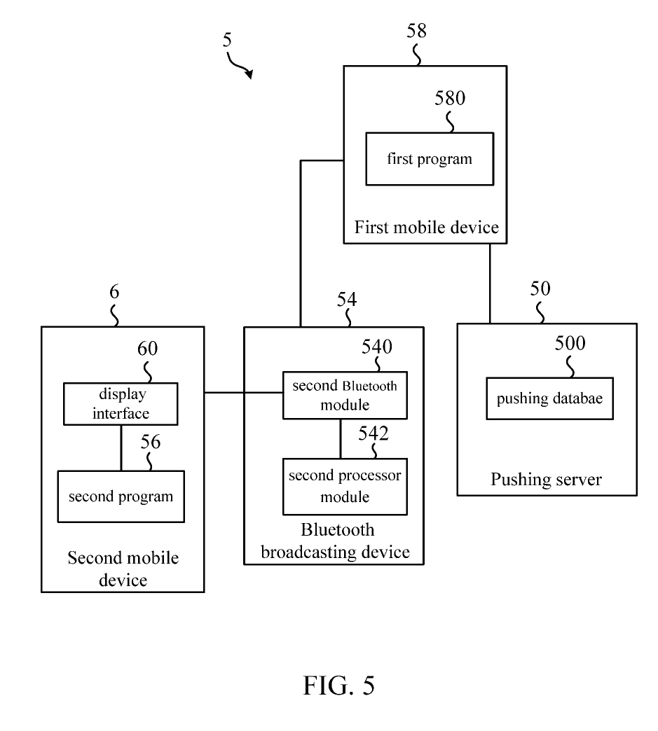

Please refer to FIG. 5. FIG. 5 shows a schematic diagram of the advertisement and message pushing system 5 in another embodiment of the present invention. The embodiment of the present invention is different from the above embodiments that the first mobile device 58 of the present invention can build the network connection with the pushing server 50 via the wireless mobile communication module and the wireless local area network module, and receive one or a plurality of the pushing signals from the pushing database 500 of the pushing server 50 via the network connection. Next, the pushing signals received by the package of the first program 580 of the first mobile device 58 become one or a plurality of Bluetooth pushing signals, and the Bluetooth pushing signals formed by the package are roughly the same; therefore, details will not be described again. When the first mobile device 58 approaches to the Bluetooth broadcasting device 54 within the region that the first mobile device 58 can build the Bluetooth connection with the Bluetooth broadcasting device 54, the first mobile device 58 builds the Bluetooth connection with the Bluetooth broadcasting device 54 and the first mobile device 58 can update the Bluetooth pushing signals packed by the first program 580 to the Bluetooth broadcasting device 54 via the Bluetooth connection. Simultaneously, the Bluetooth broadcasting device 54 can push the updated Bluetooth pushing signals to the second mobile device 6, and the second program 56 set on the second mobile device 6 can control the second mobile device 6 to display the Bluetooth pushing content of the pushing signals through words, images or sounds on the display interface 60.

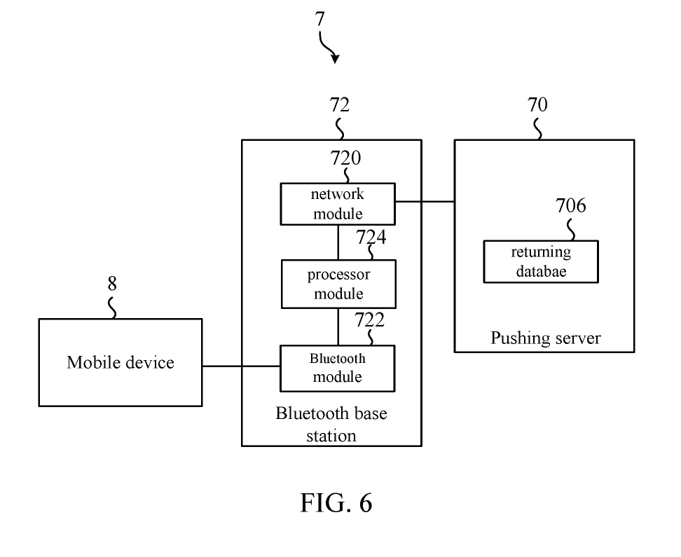

The system of the above mentioned embodiment of the present invention can be used for transmitting the data of the mobile device back and forth other than pushing the Bluetooth broadcasting signals to the mobile device. Please refer to FIG. 6. FIG. 6 shows a schematic diagram of the advertisement and message pushing system 7 in another embodiment of the present invention. As shown in FIG. 6, the embodiment of the present invention is different from the above embodiments that the pushing server 70 of the advertisement and message pushing system 7 of the present invention further comprises a returning database 706. The Bluetooth base station 72 can implement the service of returning the data, and the service transmits the Bluetooth data returning service broadcasting regularly via the Bluetooth module 722 of the Bluetooth base station 72, and the Bluetooth data returning service broadcasting transmits the Bluetooth broadcasting packet in accordance with Apple iBeacon, Google EddyStone or other Bluetooth broadcasting packet defined by other standards one by one to the mobile device 8. The Bluetooth broadcasting packet comprises a data returning service identifier. When the program of the mobile device 8 receives the data returning service identifier, the program builds connection with the Bluetooth base station 72 via the Bluetooth module of the mobile device 8, and transmits the returning data of the mobile device 8 to the Bluetooth base station 72. Furthermore, the program transmits the returning data to the pushing server 70 via the Bluetooth base station 72 and updates the data in the returning database 706.

Besides, in another embodiment of the present invention, the requirements of returning the data can be sent actively by the above-mentioned mobile device 8. To describe it in detail, the mobile device 8 preparing for returning the data can broadcast a particular service identifier externally and regularly, wherein the particular service identifier comprises Bluetooth and Bluetooth low energy defined standard profile or predefined UUID. The predefined UUID is stored in the pushing server 70 at the same time, and transmitted to the Bluetooth base station 72 via the pushing server 70 after the network connection is built. The Bluetooth base station 72 scans Bluetooth wireless channels regularly via the Bluetooth module 722 to search the surrounding for the existence of the Bluetooth device (the mobile device 8 preparing to return the data) ready to return the data. When the Bluetooth base station 72 searches to the Bluetooth device ready to return the data, the Bluetooth base station 72 builds the Bluetooth connection with the Bluetooth device. The Bluetooth base station 72 can receive the returning data of the mobile device 8 via the Bluetooth connection and the network connection, and return the returning data to the pushing server 70 to update the data in the returning database 706. Except for the above-mentioned mobile device 8, in the practice application, any Bluetooth device ready to return the data can return the data via the system in the embodiment of the present invention

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An advertisement and message pushing system, for pushing an advertisement or a message on a mobile device, comprising:
a pushing server, wherein a plurality sets of pushing signals are stored in the pushing server, and the pushing signals comprise a pushing content and a time setting respectively; and
at least one Bluetooth base station, wherein the at least one Bluetooth base station comprises a first Bluetooth module and a network module respectively, and builds a network connection with the pushing server via the network module;
wherein the pushing server transmits at least one set of the pushing signals to the at least one Bluetooth base station via the network connection, and the Bluetooth module of the at least one Bluetooth base station executes a Bluetooth signal broadcasting according to the received time setting of the pushing signals, and the Bluetooth signal broadcasting comprises the pushing content of the pushing signals.

2. The advertisement and message pushing system of claim 1, wherein in the at least one Bluetooth base station further comprises a processor module, and the processor module comprises a timing unit, and the timing unit executes the time calibration via Network Time Protocol (NTP) or IEEE 1588.

3. The advertisement and message pushing system of claim 1, further comprising a program set on the mobile device, wherein the mobile device further comprises a third Bluetooth module and a display interface; when the mobile device approaches to the at least one Bluetooth base station within a region that can receive the Bluetooth signal broadcasting, the mobile device can receive the pushing signals of the Bluetooth signal broadcasting, and then the mobile device transmits the pushing content of the pushing signals to the program of the mobile device, and the program can display the pushing content of the pushing signals through words, images or sounds on the display interface of the mobile device.

4. The advertisement and message pushing system of claim 1, further comprising a program set on the mobile device, wherein the mobile device further comprises a third Bluetooth module, a wireless network module and a display interface; when the mobile device approaches to the at least one Bluetooth base station within a region that can receive the Bluetooth signal broadcasting, the mobile device can receive the pushing signals of the Bluetooth signal broadcasting, and then the mobile device transmits the pushing content of the pushing signals to the program of the mobile device; wherein the pushing content of the pushing signals is a service identifier, and the pushing signals further comprises an extended data;
the pushing server builds an Internet connection with the mobile device via the wireless network module of the mobile device, when the program receives the pushing signals, the program transmits the service identifier to the pushing server via the Internet connection, and the pushing server searches for the collection of the pushing signals of the pushing server through transmitting back the service identifier to get a pushing signal, and transmits the extended data of the pushing signals to the mobile device via the Internet connection.

5. The advertisement and message pushing system of claim 1, further comprising:
at least one Bluetooth broadcasting device, wherein the Bluetooth broadcasting device comprises a second Bluetooth module, and builds a first Bluetooth connection with the Bluetooth base station via the second Bluetooth module;
wherein the pushing server further comprises a device database, and the device database stores a first connective corresponding relation between the at least one Bluetooth broadcasting device and the Bluetooth base station; wherein the pushing server transmits at least one set of the pushing signals to the at least one Bluetooth base station via the network connection according to the first connective corresponding relation stored by the device database, and the at least one Bluetooth base station transmits the pushing signals to the at least one Bluetooth broadcasting device via the first Bluetooth connection, and the at least one Bluetooth broadcasting device executes a Bluetooth signal broadcasting according to the time setting of the pushing signals, and the Bluetooth signal broadcasting comprises the pushing content of the pushing signals.

6. The advertisement and message pushing system of claim 5, wherein in the at least one Bluetooth broadcasting device executes the time calibration via the first Bluetooth connection.

7. The advertisement and message pushing system of claim 5, further comprising a program set on the mobile device, wherein the mobile device further comprises a third Bluetooth module and a display interface; when the mobile device approaches to the at least one Bluetooth broadcasting device within the region that can receive the Bluetooth signal broadcasting, the mobile device can receive the pushing signals of the Bluetooth signal broadcasting, and then the mobile device transmits the pushing content of the pushing signals to the program of the mobile device, and the program can display the pushing content of the pushing signals through words, images or sounds on the display interface of the mobile device.

8. The advertisement and message pushing system of claim 5, further comprising a program set on the mobile device, wherein the mobile device further comprises a third Bluetooth module, a wireless network module and a display interface; when the mobile device approaches to the at least one Bluetooth broadcasting device within the region that can receive the Bluetooth signal broadcasting, the mobile device can receive the pushing signals of the Bluetooth signal broadcasting, and then the mobile device transmits the pushing content of the pushing signals to the program of the mobile device; wherein the pushing content of the pushing signals is a service identifier, and the pushing signals further comprises an extended data; the pushing server builds an Internet connection with the mobile device via the wireless network module of the mobile device, when the program receives the pushing signals, the program transmits the service identifier to the pushing server via the Internet connection, and the pushing server searches for the collection of the pushing signals of the pushing server through transmitting back the service identifier to get a pushing signal, and transmits the extended data of the pushing signals to the mobile device via the Internet connection.

9. The advertisement and message pushing system of claim 1, further comprising a program set on the mobile device, wherein the mobile device further comprises a Bluetooth module, a wireless network module and a display interface; when the mobile device approaches to the at least one Bluetooth base station within the region that can receive the Bluetooth signal broadcasting, the mobile device can receive the pushing signals of the Bluetooth signal broadcasting, and then the mobile device transmits the pushing content of the pushing signals to the program of the mobile device; wherein the pushing signals further comprise a pushing option respectively, and the pushing option further comprises a group values, wherein each group value represents a particular user attribute collection.

10. The advertisement and message pushing system of claim 9, wherein the program compares the user attribute data in a user data file of the mobile device with the group values, and after passing the comparison, the program can display the pushing content of the pushing signals through words, images or sounds on the display interface of the mobile device.

11. The advertisement and message pushing system of claim 9, wherein the pushing server further comprises a user database, and the user database stores a user attribute collection of the mobile device, and the pushing content of the pushing signals is a service identifier, and the pushing signals further comprises an extended data; the pushing server builds an Internet connection with the mobile device via a wireless network module of the mobile device, when the program receives the pushing signals, the program transmits the service identifier to the pushing server via the Internet connection, and the pushing server searches for the collection of the pushing signals of the pushing server through transmitting back the service identifier to get a pushing signal, and transmits the extended data of the pushing signals to the mobile device via the Internet connection.

12. The advertisement and message pushing system of claim 5, further comprising a program set on the mobile device, wherein the mobile device further comprises a Bluetooth module, a wireless network module and a display interface; when the mobile device approaches to the at least one Bluetooth broadcasting device within the region that can receive the Bluetooth signal broadcasting, the mobile device can receive the pushing signals of the Bluetooth signal broadcasting, and then the mobile device transmits the pushing content of the pushing signals to the program of the mobile device; wherein the pushing signals further comprise a pushing option respectively, and the pushing option further comprises a group values, wherein each group value represents a particular user attribute collection.

13. The advertisement and message pushing system of claim 12, wherein after the program receives the pushing signals of the Bluetooth signal broadcasting, the program compares the user attribute data in a user data file of the mobile device with the group values, and after passing the comparison, the program can display the pushing content of the pushing signals through words, images or sounds on the display interface of the mobile device.

14. The advertisement and message pushing system of claim 12, wherein the pushing server further comprises a user database, and the user database stores a user attribute collection of the mobile device, and the pushing content of the pushing signals is a service identifier, and the pushing signals further comprises an extended data; the pushing server builds an Internet connection with the mobile device via a wireless network module of the mobile device, when the program receives the pushing signals, the program transmits the service identifier to the pushing server via the Internet connection, and the pushing server searches for the collection of the pushing signals of the pushing server through transmitting back the service identifier to get a pushing signal, and transmits the extended data of the pushing signals to the mobile device via the Internet connection.

15. The advertisement and message pushing system of claim 1, wherein the pushing server further comprises a device database, and the device database stores a second connective corresponding relation between the mobile device and the at least one Bluetooth base station; wherein the pushing server confirms that the transmission of the pushing signals goes through the at least one Bluetooth base station according to the second connective corresponding relation between the mobile device and the at least one Bluetooth base station in the device database to transmit the pushing signals to the corresponding at least one Bluetooth base station via the network connection of the pushing server and the Bluetooth base station.

16. An advertisement and message pushing system, comprising:
a first mobile device, having a first program, wherein the first mobile device modifies and edits at least one pushing signal through executing the first program, and the at least one pushing signal comprises a pushing content and a time setting respectively; and
a Bluetooth broadcasting device, comprising a Bluetooth module, wherein the Bluetooth broadcasting device can build a Bluetooth connection with the first mobile device via the Bluetooth module when the first mobile device approaches to the Bluetooth broadcasting device within the region that can receive the Bluetooth signal broadcasting;
wherein the first mobile device transmits the at least one pushing signal to the Bluetooth broadcasting device via the Bluetooth connection, and the Bluetooth broadcasting device executes a Bluetooth signal broadcasting 27 according to the received time setting of the pushing signals, and the Bluetooth signal broadcasting comprises the pushing content of the pushing signals;
wherein the system further comprises a second program set on a second mobile device, when the second mobile device approaches to the Bluetooth broadcasting device within the region that can receive the Bluetooth signal broadcasting, the second mobile device can receive the pushing signals of the Bluetooth signal broadcasting, and then the second mobile device transmits the pushing content of the pushing signals to the second program.

17. The advertisement and message pushing system of claim 16, wherein in the Bluetooth broadcasting device executes the time calibration with the first mobile device via the Bluetooth connection.

18. The advertisement and message pushing system of claim 16, wherein the second program can display the pushing content of the pushing signals through words, images or sounds on a display interface of the second mobile device.

19. The advertisement and message pushing system of claim 16, wherein the pushing content of the pushing signals is a service identifier, and the pushing signals further comprises an extended data; the pushing server builds an Internet connection with the second mobile device via a wireless network module of the second mobile device, when the second program receives the pushing signals, the second program transmits the service identifier to the pushing server via the Internet connection, and the pushing server searches for the collection of the pushing signals of the pushing server through transmitting back the service identifier to get a pushing signal, and transmits the extended data of the pushing signals to the second mobile device via the Internet connection.

20. An advertisement and message pushing system, comprising:
a pushing server, wherein a plurality sets of pushing signals are stored in the pushing server, and the pushing signals comprise a pushing content and a 28 time setting respectively;
a first mobile device, having a network module and a first Bluetooth module, wherein the first mobile builds a network connection with the pushing server via the network module to receive at least one set of the pushing signals from the pushing server via the network connection; and
a Bluetooth broadcasting device, comprising a second Bluetooth module, wherein the Bluetooth broadcasting device can build a Bluetooth connection with the first mobile device via the first Bluetooth module and the second Bluetooth module when the first mobile device approaches to the Bluetooth broadcasting device within the region that can receive the Bluetooth signal broadcasting;
wherein the first mobile device transmits at least one set of the pushing signals to the Bluetooth broadcasting device via the Bluetooth connection, and the Bluetooth broadcasting device executes a Bluetooth signal broadcasting according to the received time setting of the pushing signals, and the Bluetooth signal broadcasting comprises the pushing content of the pushing signals.

21. The advertisement and message pushing system of claim 20, wherein in the Bluetooth broadcasting device executes the time calibration with the first mobile device via the Bluetooth connection.

22. The advertisement and message pushing system of claim 20, further comprising a second program set on the second mobile device, when the second mobile device approaches to the Bluetooth broadcasting device within the region that can receive the Bluetooth signal broadcasting, the second mobile device can receive the pushing signals of the Bluetooth signal broadcasting, and then the second mobile device transmits the pushing content of the pushing signals to the second program of the second mobile device, and the second program can display the pushing content of the pushing signals through words, images or sounds on the display interface of the second mobile device.

23. The advertisement and message pushing system of claim 20, further comprising a second program set on the second mobile device, when the second mobile device approaches to the Bluetooth broadcasting device within the region that can receive the Bluetooth signal broadcasting, a third Bluetooth module of the second mobile device receives the pushing signals of the Bluetooth signal broadcasting, and then the second mobile device transmits the pushing content of the pushing signals to the second program; wherein the pushing content of the pushing signals is a service identifier, and the pushing signals further comprises an extended data; the pushing server builds an Internet connection with the second mobile device via a wireless network module of the second mobile device, when the second program receives the pushing signals, the second program transmits the service identifier to the pushing server via the Internet connection, and the pushing server searches for the collection of the pushing signals of the pushing server through transmitting back the service identifier to get a pushing signal, and transmits the extended data of the pushing signals to the second mobile device via the Internet connection.
